(19) United States
(12) Patent Application Publication
(10) Pub. No.: US 2008/0119147 A1
(43) Pub. Date: May 22, 2008

(54) Frequency modulation system circuit for antennas

(75) Inventors: Xiao-Liu YUAN, Nanking City (CN); Song GAO, Nanking City (CN); Hao CHENG, Nanking City (CN)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/907,935

(22) Filed: Oct. 18, 2007

(30) Foreign Application Priority Data
Nov. 17, 2006 (TW) 95142733

(51) Int. Cl. H04B 1/02; H01Q 1/26; H04M 1/02

(52) U.S. Cl. 455/129; 343/700 R; 455/205; 455/550.1

(57) ABSTRACT

A frequency modulation (FM) circuit, built in an electronic device, comprises an antenna circuit for signal receiving, an FM module connected with the antenna circuit for transforming FM signals of incoming signals into respective audio signals, and a controller connected with the FM module for forwarding the audio signals. The antenna circuit further includes an antenna, a low noise amplifier (LNA) and its matching circuit, a support structure, and a feed line. By providing the LNA and its matching circuit, the receiving sensitivity of the antenna circuit can be improved and the whole antenna circuit can be reduced to a size that is easily accommodated inside the electronic device. Also, an antenna circuit for the FM system circuit is provided as well.

This application claims the benefit of Taiwan Patent Application Serial No. 95142733, filed Nov. 17, 2006, the subject matter of which is incorporated herein by reference.

### BACKGROUND OF THE INVENTION

(1) Field of the Invention

The invention relates to a frequency modulation (FM) system circuit, and more particularly to the FM system circuit that can enhance the receiving sensitivity by including a low noise amplifier (LNA).

(2) Description of the Prior Art

It is well to see that the recent technology advance in communication industry is based on the significant progresses in semiconductor industry and the digital signal processing (DSP) technology. Among three major categories of the communication industry including the mobile communication, the satellite communication and the photo fiber communication, the mobile communication is the most crucial one close to daily life. Prospectively with the recent communication technology, variety designs in antennas for the industry have been seen and form a mainstream demand in a slim-and-mini product. Thus, a balance in the antenna design between the space limitation and the communication quality has become an issue.

Currently, a conventional mobile phone having the FM antenna is generally equipped with an about 1-m headphone cable as its antenna. In order to fulfill a 87.5-108 MHz FM broadcasting, a 69-86 cm antenna (accounting for ¼ wavelength) is needed. Apparently, in a further consideration of a necessary spacing to the ground, such an antenna is too long to be built into the communication end of the mobile phone.

In some current applications, a coiled ceramic bar is used to increase the dielectric constant so as to reduce the antenna size. It is also seen that another antenna is formed by circling the main board of the device. However, the former design needs a larger interior room to contain the coiled ceramic bar, and the latter usually meets a ground-spacing problem between the wrapped antenna and the main board.

Therefore, it is the incentive of the present invention to configure an FM system circuit for improving the receiving sensitivity of the antenna and compensating signal loss of the antenna, such that the size of the built-in FM antenna can be reduced to an acceptable extent.

### SUMMARY OF THE INVENTION

Accordingly, it is an aspect of the present invention to provide a frequency modulation (FM) system circuit for antennas, which introduces a low noise amplifier (LNA) at a front end of the antenna so as to enhance receiving sensitivity of antenna and to make possible an FM antenna built in a mobile phone.

In accordance with one embodiment the present invention, the FM system circuit built in an electronic device comprises an antenna circuit for signal receiving, an FM module connected with the antenna circuit for transforming FM signals in incoming signals into respective audio signals, and a controller connected with the FM module for forwarding the audio signals. The antenna circuit further includes an antenna, an LNA, a matching circuit for the LNA, a support structure, and a feed line. By providing the LNA and the matching circuit, the receiving sensitivity of the antenna circuit can be improved and the whole antenna circuit can be reduced to a size that is easily accommodated inside the electronic device.

In accordance with another embodiment of the present invention, the antenna circuit, built in an electronic device, applied to an FM system, and constructed in front of an FM module of the FM system, comprises an antenna, a support structure made of a plastics, a feed line coupling the antenna and wrapped partly on a surface of the support structure, and an LNA and its matching circuit for compensating antenna signal loss and amplifying the signal before forwarded to the FM module. By providing the LNA and the matching circuit to enhance the receiving sensitivity of the antenna circuit, the antenna circuit can then be reduced to a size that is easily accommodated inside the electronic device.

In accordance with embodiments of the present invention, the FM system circuit is constructed at the front end of the FM module. The addition of the LNA and the matching circuit in the antenna circuit can enhance antenna's receiving sensitivity, compensate the antenna's signal loss, and increase the signal-to-noise (S/N) ratio of the FM module; such that the purpose of building an FM antenna inside the electronic device can be fulfilled.

### BRIEF DESCRIPTION OF THE DRAWINGS

The present invention will now be specified with reference to its preferred embodiment illustrated in the drawings, in which:

FIG. 1 is a schematic block diagram of a FM system circuit in accordance with one embodiment of the present invention;

FIG. 2 shows a frequency-modulation low noise amplifier (FM-LNA) and its matching circuit in accordance with another embodiment of the present invention;

FIG. 3A is a perspective view of a circuit board and a support structure in accordance with one embodiment of the present invention;

FIG. 3B is a bottom view of FIG. 3A;

FIG. 4 is a waveform chart of a standing wave output from the FM-LNA and its matching circuit in accordance with one embodiment of the present invention;

FIG. 5 is a waveform chart of transmission power of the FM-LNA and its matching circuit in accordance with one embodiment of the present invention;

FIG. 6 shows a relationship between collector voltages and power gains of a bipolar junction transistor of the FM-LNA and its matching circuit in accordance with one embodiment of the present invention; and

FIG. 7 shows a relationship between emitter currents and noise figures of the bipolar junction transistor of FIG. 6.

### DESCRIPTION OF THE PREFERRED EMBODIMENT

The invention disclosed herein is directed to a frequency modulation system circuit for antennas. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In accordance with embodiments of the present invention, a design of an FM system circuit is applied to an FM antenna. In the circuiting of the antenna, an LNA is included to enhance the receiving sensitivity of the antenna and to compensate the signal loss of the antenna, such that the antenna size can be reduced and the product FM antenna can be easily built into an electronic device.

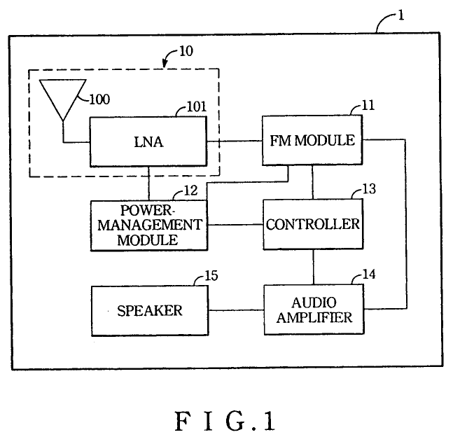

Referring now to FIG. 1, a schematic block diagram of a FM system circuit in accordance with one embodiment of the present invention is shown. The FM system circuit 1 includes an FM antenna circuit 10, an FM module 11, a power-management module 12, a controller 13, an audio amplifier 14 and a speaker 15. The FM antenna circuit 10 further includes a built-in antenna 100, an FM-LNA and its matching circuit 101, a feed line (not shown in the figure), and a support structure (not shown in the figure). The FM module 11 for processing FM signals further includes circuits at least for a voltage control oscillator (VCO), a phase-locked loop (PLL) and a mixer. The controller 13, connected with the FM module 11, is capable of controlling the operation modes (including output of audio signals) of the FM module 11, and to receive control parameters such as gains, operation frequencies and so on. The power-management module 12 supplies electric power to the FM system circuit. The audio amplifier 14 is used to amplify the audio power so as to energize the speaker 15 for voicing.

When the antenna 100 receives an FM signal, the signal is amplified by the LNA and its matching circuit and then forwarded to the FM module 11. The FM module 11 transforms the amplified FM signal into a stereo audio signal, then the controller 13 would control the FM module 14 to forward the stereo audio signal to the audio amplifier 14 for further amplifying, and finally the amplified stereo audio signal can be broadcasted as an FM radio through the speaker 15.

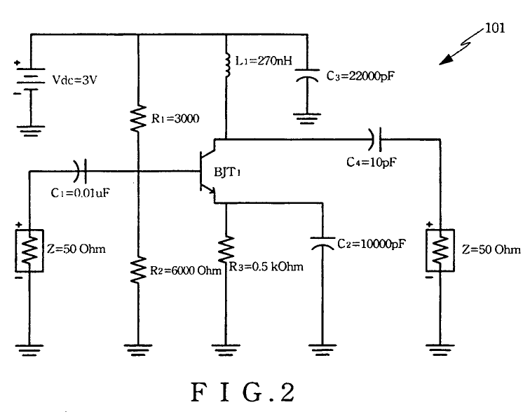

Referring now to FIG. 2, a circuitry for a FM-LNA and its matching circuit in accordance with another embodiment of the present invention is shown. The FM-LNA and its matching circuit 101 include plural capacitors C1, C2, C3, C4, an inducer L1, plural resistors R1, R2, R3, an electroporator Z and a bipolar junction transistor BJT1.

As shown, a 3-V source is used to power the FM-LNA. The inducer L1 can be a high-Q (quality factor) product to supply a DC feed and an AC match. The resistors R1, R2, R3 can apply the resistors in the market, in which the resistor R3 is used as a feedback resistor to restrain temperature drift and to receive an emitter current of the bipolar junction resistor BJT1. The capacitor C1 is a signal (or input) coupling capacitor, the capacitors C2 and C3 are hi-frequency ground capacitors, and the capacitor C4 is used to form an output match loop with the inducer L1 so as to match the following 50-Ohm electroporator Z. Upon such an arrangement, an FM radio-frequency harmonic network is formed by the built-in antenna, the capacitor C1, the resistors R1, R2, R3, and the bipolar junction transistor BJT1. The FM bandwidth power gain of the network is about 20 dB, and the receiving sensitivity of the antenna is improved by 10 dB.

By providing the FM-LNA and its matching circuit 100 to lead the FM module according to embodiments of the present invention, the receiving sensitivity of the FM antenna can be improved and the antenna signal loss can be substantially compensated. For the FM-LNA has a feature of cutting out high-frequency signals, a quasi band-pass filter is then formed in front of the FM module, such that noises fed from the antenna can be reduced and thus the signal-to-noise (S/N) ratio of the FM module can be increased.

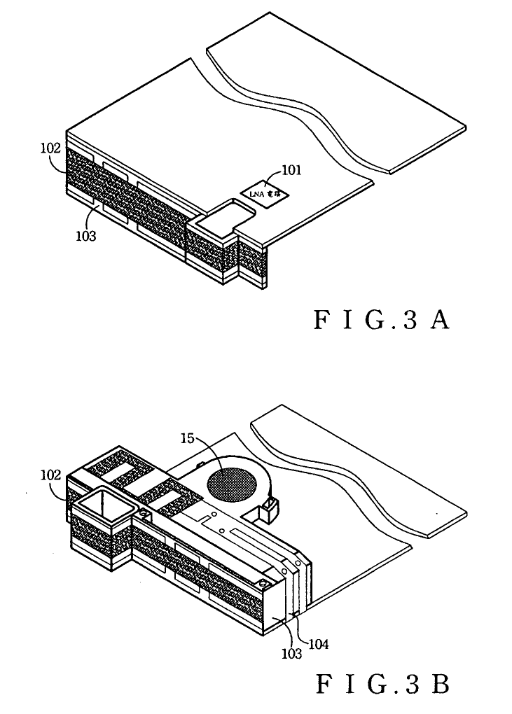

Referring now to FIG. 3A and FIG. 3B, an assembly of a circuit board and a support structure in accordance with one embodiment of the present invention is shown in two perspective views, in which the connection relationship between the support structure 103 and the circuit board of the electronic device is clearly shown. The feed line 102 is attached to and runs around the support structure 103. At a back side of the circuit board, an antenna feed line 104 is also attached to the support structure 103 and extended to connect with the feed line 102. The support structure 103 can be used to mount the speaker 15. It is shown that the antenna feed line 104 is positioned between the support structure 103 and the circuit board.

In one embodiment of the present invention, the feed line 102 is a cupper foil formed on the support structure 103, with a length of 36˜38 mm, a width of 6˜6.8 mm, and a spacing of 5˜7 mm to the ground. The support structure 103 can be made of a plastics with a dimension compared to the cupper foil. The antenna feed line 104 can be made of a phosphor bronze. In consideration of the formation of the built-in antenna not to enlarge the size of the electronic device such as the mobile phone, a walkman, and so on, the feed line 102 is limited to formed as the copper foil that can be FM bandwidth coupled to lead the LNA circuit 101. That is to say that the built-in antenna of one embodiment of the present invention is actually composed of the FM-LNA 101, the feed line 102 and the support structure 103.

In the present invention, the FM-LNA circuit and its matching circuit, the feed line, and the support structure are all formed in cooperation. Yet, the present invention is not limited to the aforesaid embodiments. Feasibly, the feed line and the support structure can be further enlarged or diminished according to any change in the FM-LNA circuit including the change in electronic elements, the change in gains, and any the like.

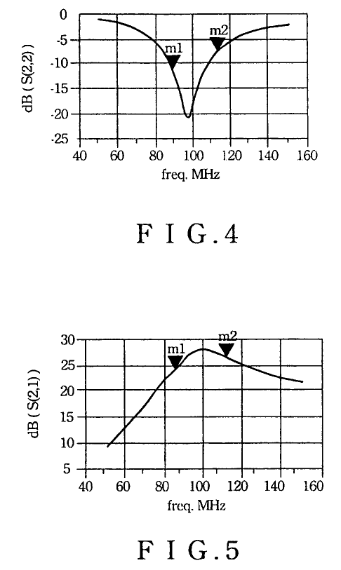

Referring now to FIG. 4, a waveform chart of a standing wave output from the FM-LNA and its matching circuit in accordance with one embodiment of the present invention is shown. The standing wave features the matching characteristics within the operational bandwidth of the FM built-in antenna. As shown, the standing wave between m1 and m2 is less than −10 dB, in which the m1 point shows a 88 MHz at −10.771 dB and the m2 point shows a 100 MHz at −8.727 dB.

Referring now to FIG. 5, a waveform chart of transmission power of the FM-LNA and its matching circuit in accordance with one embodiment of the present invention is illustrated. As shown, the transmission power gains between m1 and m2 are all greater than 20 dB, in which the m1 point shows a 85 MHz at 24.365 dB and the m2 point shows a 110 MHz at 26.701 dB.

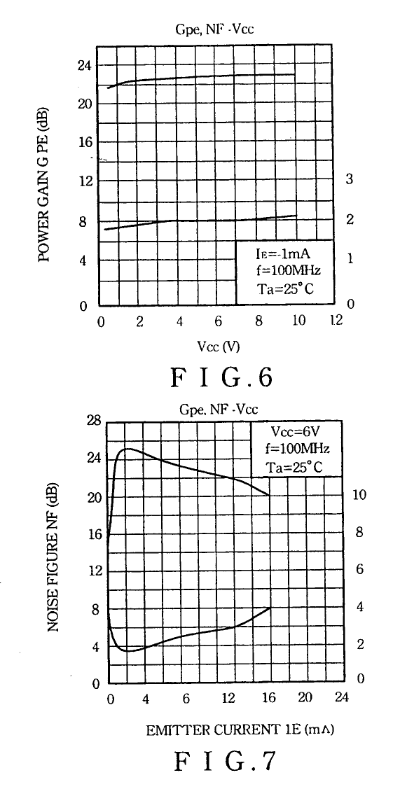

Refer now to FIG. 6 and FIG. 7, which FIG. 6 shows a relationship between collector voltages and power gains of the bipolar junction transistor of the FM-LNA and its matching circuit in accordance with one embodiment of the present invention, and FIG. 7 shows a relationship between emitter currents and noise figures of the same bipolar junction transistor. In FIG. 6, it is shown that the power gain differences between any two work voltages of the FM-LNA circuit are all less than 2 dB. In FIG. 7, when the emitter current is at 2 mA, a match between the power gain and the noise figure reaches an optimal pair.

By providing the FM system circuit of the present invention to lead the FM module (i.e. adding an LNA and its matching circuit into the antenna circuit), the antenna receiving sensitivity can be improved, the signal loss can be compensated, and the input N/S ratio of the FM module can be increased; such that the object of building an FM antenna inside the electronic device can be fulfilled.

While the present invention has been particularly shown and described with reference to a preferred embodiment, it will be understood by those skilled in the art that various changes in form and detail may be without departing from the spirit and scope of the present invention.

I claim:

1. A frequency modulation (FM) circuit, built in an electronic device, comprising:
an antenna circuit, capable of receiving signals, further including an antenna, a low noise amplifier (LNA) and its matching circuit, a support structure and a feed line, in which the LNA and its matching circuit is to increase receiving sensitivity of the antenna circuit;
an FM module, capable of processing FM signals of the signals and transforming the FM signals into respective audio signals, connected with the antenna circuit; and
a controller, capable of controlling the FM module to output the audio signals, connected with the FM module.

2. The FM system circuit according to claim 1, further comprising a power-management module for powering said FM system circuit.

3. The FM system circuit according to claim 1, further comprising an audio amplifier for amplifying said audio signals output from said FM module.

4. The FM system circuit according to claim 3, further comprising a speaker for broadcasting said audio signals amplified by said audio amplifier.

5. The FM system circuit according to claim 1, wherein said electronic device is a mobile phone.

6. The FM system circuit according to claim 1, wherein said electronic device is a walkman.

7. The FM system circuit according to claim 1, wherein said support structure is made of a plastics.

8. The FM system circuit according to claim 1, wherein said feed line is made of a copper foil.

9. An antenna circuit, built in an electronic device, applicable to a frequency modulation (FM) system, constructed in front of an FM module of the FM system for receiving signals, comprising:
an antenna;
a support structure, connected with a circuit board of the electronic device, made of a plastics;
a feed line, coupled with the antenna, made of a metal foil, attached to a surface of the support structure; and
a low noise amplifier (LNA) and its matching circuit, used to compensate signal loss of the antenna, to amplify the signals before being forwarded to the FM module, and so as to increase receiving sensitivity of the antenna circuit.

10. The antenna circuit according to claim 9, wherein said feed line is coupled with said LNA and its matching circuit.
